(19) United States
(12) Patent Application Publication
(10) Pub. No.: US 2021/0344766 A1
(43) Pub. Date: Nov. 4, 2021

(54) SYSTEMS AND METHODS FOR DECENTRALIZATION OF BLOCKCHAIN-BASED PROCESSES EMPLOYING A BLOCKCHAIN-ASSOCIATED FRONT END OR BLOCKCHAIN-ASSOCIATED USER INTERFACE

(71) Applicant: TON Venture Studio Ltd., Road Town (VG)

(72) Inventors: Nikita MONAHOV, Penza (RU); Dmitry GOROSHEVSKY, Varna (BG); Anton SERKOV, Vologda (RU); Michail VLASOV, Ufa (RU); Boris IVANOVSKY, St. Petersburg (RU); Andrei ZHOGIN, Novosibirsk (RU)

(21) Appl. No.: 17/244,478

(22) Filed: Apr. 29, 2021

Related U.S. Application Data
(60) Provisional application No. 63/017,042, filed on Apr. 29, 2020.

(51) Int. Cl. H04L 29/08; H04L 9/06; G06F 16/901

(52) U.S. Cl. CPC H04L 67/26; H04L 2209/38; G06F 16/9024; H04L 9/0618

(57) ABSTRACT

Decentralized blockchain-associated systems and apparatuses including specialized blockchain-integrated nodes that have a decentralized bot, a smart contract, and business logic, with the decentralized performing sequences of user actions throughs calls to functions of the smart contract. Methods for the use of decentralized bots for decentralized smart contract verification and message notification.

### CLAIM OF BENEFIT OF PRIOR-FILED APPLICATION

This application claims priority to, and the benefit of, U.S. Provisional Application No. 63/017,042, filed Apr. 29, 2020, titled “End-to-End Decentralization PA”, the entire disclosure of which is incorporated by reference.

### FIELD OF THE INVENTION

The present invention relates to systems, methods and apparatuses for carrying out blockchain-based processes. Specifically, embodiments include systems, methods and apparatuses to carry out electronic processes over a computer network in a manner that reduces reliance on trust in private entities and their potentially hackable, privately censorable and/or non-verifiable privately managed software and/or hardware.

### BACKGROUND OF THE INVENTION

A blockchain is a form of network that allows for certain computations performed on the blockchain to be verified by participating persons or entities. For example, results of execution of smart contracts and programs that are processed by a blockchain may be verifiable by multiple nodes of the blockchain. This multi-node verifiability achieves an aspect of decentralization with respect to these processes.

However, the results of such processes, for example the results of smart contract execution, are delivered to users through the use of centralized resources, which may be software or hardware-based services controlled by private persons or entities.

As has been explained by Vitalik Buterin at https://medium.com/@VitalikButerin/the-meaning-of-decentralization-a0c92b76a274, while decentralization is important within the blockchain community, its meaning is poorly understood.

The inventors of the inventions described herein have realized the use of such centralized resources may compromise the integrity of the results of, and interaction with, such processes. In particular, the end user is not able to verify the correctness of his or her interaction with blockchain-based process (e.g. smart contract execution) through the chosen centralized resource-employing interaction channel. That is, the inventors described herein have realized the existence of a particularized failure of decentralization within available blockchain systems and methods.

The inventors have also realized that inaccurate or potentially inaccurate claims to decentralization are often made within blockchain development communities, for example based on optimizations mainly related to consensus mechanism and data exchange protocols. For example, to the extent such claims may be made based on Proof-of-Work and/or Proof-of-State consensus protocols, or their derivatives, there nonetheless remain decentralization problems (that is, the existence of a degree of centralization) at both the mining/staking and the front-end levels.

Similar problems exist in current blockchains which support smart contracts, (that is, an ability to perform and validate arbitrarily defined computations) in which user interaction with the results of such computation is generally performed using a front end library (e.g. Web3 in the Ethereum blockchain). This library performs blockchain-related tasks with blockchain data presented to a user, and an IPFS (InterPlanetary File System) may be used to store data. However, the inventors have realized this combination is not sufficient to preserve full decentralization of end user interactions with a blockchain system, and in particular fails to guarantee resistance to private censorship and to guarantee security.

As explained for example at https://web3js.readthedocs.io/en/v1.2.6/, Web3 (e.g. in the form of the Web3.js library collection) allows for “you to interact with a local or remote Ethereum node, using an HTTP or IPC connection.” In effect, it functions generally as an SDK giving a user the ability to work with blockchain in a web browser—a form of user interface. Web3.0 (which is understood to employ this Web3.js library collection) is considered an advance of Web2.0 and Web1.0 for this reason. However, the inventors have again noticed that such interaction retains an aspect of centralization in that users continue to interact with elements of information outside of the blockchain, which elements are presented to them by application user interface. Thereby, the inventors have noticed, risks of mutability, censorship, tampering, and failures to due to faults continue to exist in Web3.0 when used to access blockchain through such user interface. Accordingly, it is the understanding of the inventors that, under such circumstances, where a degree of centralization at a link in the overall process calls into question the overall claim of decentralization, decentralization is not truly present.

IPFS is a protocol and peer-to-peer network for storing and sharing data in a distributed file system. As has been explained for example on Wikipedia's entry for the IPFS, (https://en.wikipedia.org/wiki/InterPlanetary_File_System) IPFS uses content-addressing to uniquely identify each file in a global namespace connecting all computing devices. IPFS therefore allows for storage of content in a distributed system and for users to be directed to the content.

However, the inventors have realized that even if Web3.0 user interface-based blockchain access were combined with IPFS, that would not be sufficient to arrive at true decentralization.

The inventors have realized that there is a need for systems, methods, and apparatuses for creating a comprehensive user experience without relying on private “trusted” infrastructure, and in particular for achieving true end-to-end decentralization of blockchain processes, notably with respect to the user interaction aspects thereof.

### SUMMARY OF THE INVENTION

This disclosure addresses deficiencies with respect to decentralization in overall blockchain experiences by providing tools (in the form of systems, methodologies and apparatuses) allowing for creation of a comprehensive user experience involving front-end or user interfaces as well as blockchain processes (e.g. smart contracts) without relying on so-called “trusted” private infrastructure.

Accordingly, according to aspects of the invention, a closer approximation of true end-to-end decentralization, or indeed true end-to-end decentralization, can be achieved.

### BRIEF DESCRIPTION OF THE DRAWINGS

Further features and advantages of the invention may be understood by reviewing the following detailed description of the preferred embodiments of the invention taken together with the attached drawings, in which:

FIG. 1 is a system and flow diagram illustrating a generally centralized system architecture and information flow under the Web2.0 prior art framework.

FIG. 2 is a system and flow diagram illustrating a generally partially decentralized system architecture and information flow that may be realizable under the Web3.0 prior art framework.

FIG. 3 is a system and flow diagram, compatible with enabling decentralized user interaction with blockchain processes and the avoidance of reliance on “trusted” systems, according to an exemplary embodiment of the present invention.

FIG. 4 is a flow diagram for an action loop, according to an aspect of the present invention;

FIG. 5 is a legend for the specific purpose of a fuller understanding of the exemplary function descriptions usable in accordance with embodiments of the present invention, as set out in FIGS. 6A-6O.

FIGS. 6A-6O set out exemplary command function descriptions usable in connection with the blockchain-integrated and decentralized systems, methods and apparatuses of the present invention.

FIG. 7 is an object and action list for the specific purpose of a fuller understanding of the exemplary function descriptions usable in accordance with embodiments of the present invention, as set out in FIGS. 6A-6O.

FIG. 8 is an exemplary system architecture and functionality diagram showing interaction between a DeBot Browser, a number of DeBots, and a blockchain, according to embodiments of the present invention.

FIG. 9 is an exemplary function and information flow diagram showing interaction between a DeBot Browser, a DEngine, a DeBot, and a blockchain according to embodiments of the present invention.

### DETAILED DESCRIPTION OF THE DRAWINGS AND PREFERRED EMBODIMENTS

According to embodiments of the present invention, there are systems, methods, and apparatuses that creates a comprehensive user experience without relying on trusted infrastructure. In certain such embodiments, the user interface or front end itself may be written inside of a smart contract itself, which may thereby facilitate the user interface or front end being decentralized. Accordingly, in certain embodiments, End-to-End Decentralization at a user interaction level may be achieved. In further embodiments, a front-end application (including, for example, any web browser-based front end or purposely-built front end software) can render an entire user experience and interface without relying on a centralized or other “trusted” server.

It will be understood, in connection with the fuller understanding of this description, that certain terms used herein may be understood as, in certain embodiments, being associated with particular attributes and functionalities. “DeBot” may be a smart contract facilitating conversation-like flow communication with a target smart contract. “Target smart contract” may be a smart contract for which DeBot is created, with the DeBot having the ability to be an interface to this smart contract. A “DeBot protocol” may be a set of rules describing the communication between a browser and a DeBot, such as how to call DeBot functions and how to interpret the DeBot's answers. A “DeBot engine” or “DEngine” may be a program component that may execute DeBot and parse its answer using a DeBot protocol. A DeBot browser may be a program, which may create instances of DEngine for executed DeBots and may render the user interface.

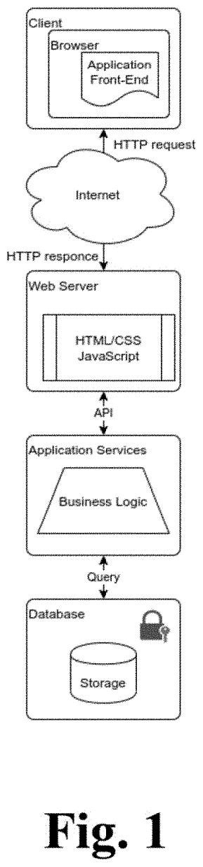

FIG. 1 is a system and flow diagram illustrating a generally centralized system architecture and information flow under the Web2.0 prior art framework.

Such systems are server centered and centralized. They are not blockchain-integrated and rely on private database storage and private web servers to provide Internet-based application services to a client who is employing a browser having an application front-end, through intermediary use of such techniques HTML/CSS JavaScript and application programming interfaces (APIs).

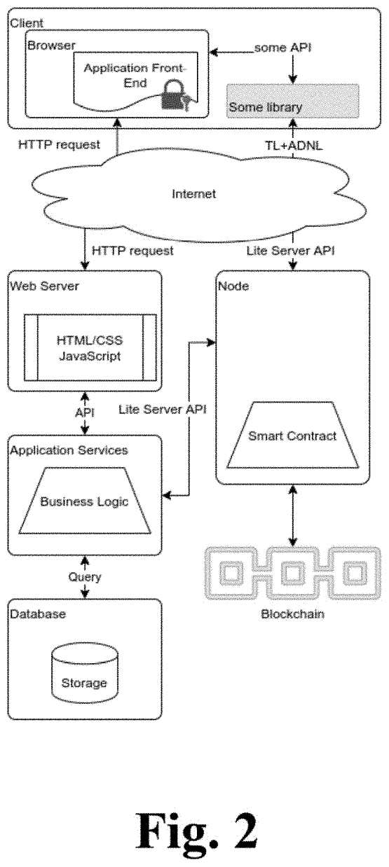

FIG. 2 is a system and flow diagram illustrating a generally partially decentralized system architecture and information flow that may be realizable under the Web3.0 prior art framework.

Comparing Web3.0, as exemplified for example in FIG. 2, and Web2.0 (as exemplified for example in FIG. 1), It can be seen that the Web3.0 system architecture is partially decentralized, as compared with that of Web2.0. In particular, the Web3.0 architecture as shown employs a node that is integrated with a blockchain (for example, the Ethereum blockchain). To a limited extent, the client may also communicate over the Internet with that node and thereby access blockchain-integrated smart contracts. However, application services, as Web2.0, rely on private database storage and private webs servers to provide Internet-based application services to the client, through intermediary use of such techniques as HTML/CSS JavaScript and application programming interfaces (APIs).

FIG. 2 represents a common implementation. A user interface is provided by a webserver. An application is running on the server and displayed in the user browser (or on mobile device). A user performs many usual operations with the website content on the server. Only on limited occasion, is a web3.0.js called from the end user device signed with user private key so as to interact with the blockchain.

The Web3.0 system, stated differently, is not a monolithic system, but rather is fragmented. It may have many components such as IPFS database for storage, others for address discovery and others still may be used for storage queries. Smart contracts may be executed in one location and the data manipulated by the smart contracts may be stored in another. As the data may for example comprise meeting the business logic located only on an end user device, the inventors have realized that computations performed on such data cannot be verified by a blockchain, despite this being the sort of smart contract-like computation that is theoretically blockchain-verifable. While limited verification may be available in the form of a hash of data stored elsewhere, the inventors have realized that interaction with said data is static. As a result, the inventors have further noticed that a system vulnerability is created. For example, if a man-in-the middle attack is performed on the user device level—the security of the Web3.0 system can be compromised.

Even supposing that such implementations were to make the advance necessary to store application data (such as a website) in an IPFS database, the web3.0.js would nonetheless be called to perform operations with a blockchain. The inventors have realized that this is not equivalent to blockchain-integration of a library or a smart contract associated with the user application interaction. Again, full blockchain-based verification, of what has actually happened to the data that was stored and received from the IPFS on the user device, would not be achievable under such a system.

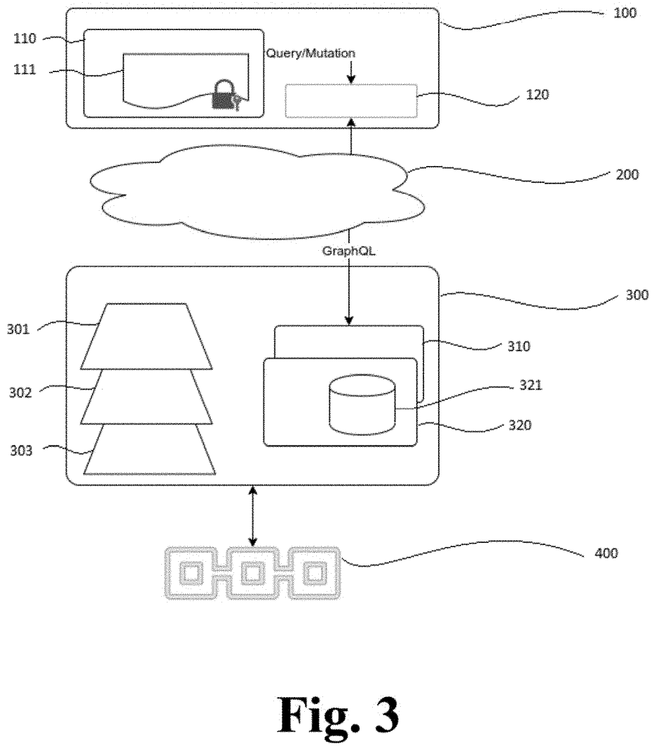

FIG. 3 is a system and flow diagram, compatible with enabling decentralized user interaction with blockchain processes and the avoidance of reliance on “trusted” systems, according to an exemplary embodiment of the present invention. The system according to such embodiments enables or approximates what is referred to herein as end-to-end decentralization.

As compared to Web3.0 implementations, such embodiments of the present invention eliminate centralized aspects to arrive at or approximate this end-to-end decentralization.

Such systems of the present invention may be accessible by a client 100. The client may access the system through a browser or other stand-alone application 110, which may include a secured application front-end 111. An interface such as a software development kit (SDK) 120 at the client 100 end may be used for communication (e.g. Internet 200 based communication) with a specialized node 300. GraphQL is one illustrative example of a language for query/mutation-based communication with the specialized node 300 that may be employed.

The specialized node 300 may include a server 310 such as a Q-Server for purposes of this communication, which may be associated with a database 320 having storage 321. Moreover, the specialized node may have a decentralized bot (referred to herein as a “DeBot”) 301, smart contracts 302, and business logic 303. The specialized node is integrated with blockchain 400. In certain embodiments, this may describe the entirety of this system, without extraneous components associated with the specialized node 300 that are not Blockchain-associated and therefore rely upon trust rather than verifiability (as seen for example towards the bottom-left of FIG. 2).

In a preferred embodiment, the smart contract 302 itself contains the DeBot 301 which in turn serves as the user interface. The business logic 303 may be contained within the smart contract 302 as well. In alternate embodiments, rather than employing the DeBot 301, the user interface may be drawn for the benefit of client 100, for example in the form of a graphical user interface.

In a further preferred embodiment, a sequence of actions of the user associated with client 100 may be performed by the DeBot 301 itself through calls to smart contract functions of the DeBot 301. This may be achieved employing a local virtual machine of a particular blockchain such as blockchain 400. The result of the action sequence can, for example at any time, be transmitted to the remote smart contract together with the sequence of user performed actions itself and the whole interface interaction can accordingly be verified remotely by the blockchain—including the transaction resulting from the sequence of actions.

In order to address the user at client 100, an address of the smart contract 302 and/or DeBot 301, such a blockchain address, may be communicated to the user. The address may be further abstracted, for example employing a blockchain-based DNS service.

According to embodiments of the invention, the DeBot 301 may be a smart contract 302 facilitating a conversation-like flow communication with a target smart contract. The target smart contract in turn, is the smart contract for which the DeBot 301 is created. The DeBot 301 may serve as an interface to this target smart contract.

According to further embodiments of the invention, there may be a DeBot browser in the form of a program that executes the DeBot 301 and parses the answer of the DeBot 301 using a DeBot protocol. The DeBot protocol may be a set of rules describing the communication between the DeBot browser and the DeBot 301. In particular, the DeBot protocol may specify how to call DeBot 301 functions and how to interpret the answer of the answer or output of DeBot 301 to such function calls.

According to certain embodiments of the invention, a platform, referred to herein as a “DeBot platform,” may include a DeBot smart contract, a DeBot browser, and one or a number of target smart contracts. These elements may comprise the entirety of such a DeBot platform.

In certain embodiments, a single target smart contract may have or be associated with several DeBots. In further embodiments, such DeBots may be deployed to the blockchain 400. A DeBot, prior to being run or executed, may be downloaded to the client 100 and may be executed inside a DeBot browser instance.

Communication may occur between the DeBot browser and the DeBot in the form of an “action”. The DeBot may be called by the DeBot browser by the browser executing such an action. The DeBot may also return results to a call in the form of an action or a set of actions.

In some embodiments, an action may include or consist of one or more or all of a description, a name, a type, an id, a current step and a context.

Exemplary action types may a run_action, a run_method, a send_msg, and invoke_debot. A run_action action type may tell a browser to receive some data from the user associated with client 100 and call a DeBot function associated with the action. Such run_action may contain a description or other user friendly text to display to the user, a name of DeBot function to call, a markup of UI elements to be rendered by the DeBot browser, and/or a current action step (for example where the run_action pertains to a complex action). Pseudocode associated with such a run_action may be in the form, for example, of:

action {

description: “enter your name”,
name: “enterName”,
type: “run_action”,
step: 0, markup: “{ input: {“name”: “inputName”, “type”: “text” }
} ”

}

A run_method action type may be used call the get-method of a target smart contract. Such action type may contain a name a name of the get-method to call from the target smart contract and may further contain instructions on processing call results: for example, whether it should be printed to the user or used to call a DeBot function.

A send_msg action type may be used to send a message to a target smart contract, and may contain a message prepared by a DeBot, for example a message that may be signed and sent to the target smart contract.

An invoke_debot action type may be used to call an action from another DeBot, and may contain an address of a target DeBot, and the name and, if applicable, parameters, of the target DeBot action. Based on such action action type, the DeBot browser may download the target DeBot and execute the specified action.

The current set of actions may be understood, according to an aspect of the present invention, to be defined by the “state of DeBot.” Such action set or state may be retrievable from the DeBot for example by calling a getActions function, and may be verified for example by calling a validateState function of a DeBot contract on the blockchain 400.

According to further aspects of the invention, a protocol may be applicable with respect to the DeBot, which protocol may include a start function, an action loop, and a DeBot interface.

The start function may serve as an entry point to the DeBot, for example by serving as a preparation to step to correctly generate a set of initial actions. In this way, the start function may return a list of actions to perform at DeBot initiation, for example before starting communication with the user associated with client 100.

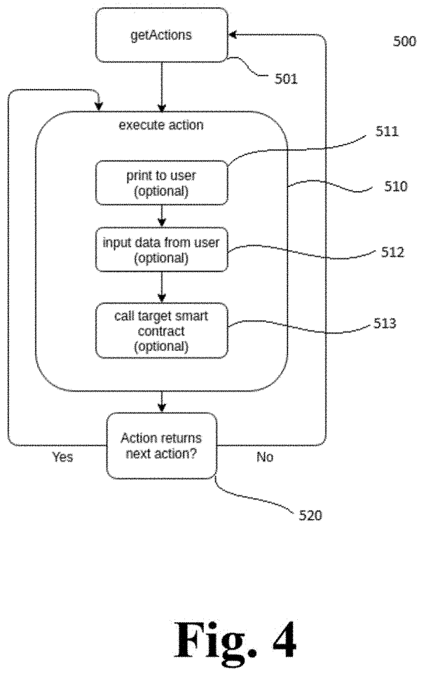

The action loop 500, for example as shown at FIG. 4, may be initiated after completion of the start function. In an exemplary aspect of the present invention, the action loop may function by the DeBot browser, in the event it has no actions set to execute at a time, calling, at step 501, the DeBot's getActions function and thereby receiving a current set of actions, as every DeBot action may be configured so as to produce a set of zero or more next actions. As long as the browser has a positive number of unexecuted actions, it executes those actions at step 510, and, depending on the actions, this may involve such step or steps as step 510 (printing to the user), step 511 (inputting data from the user), and/or step 511 (calling a target smart contract). After execution of the current action or actions, at step 520 a determination is made as to whether such action or actions has returned next actions. If so, those actions are executed at step 510. If not, step 501 again calls the DeBot's get actions function to retrieve an additional current set of actions, and so on.

In certain embodiments according to the present invention, the DeBot interface may include for example start( ), getActions( ), getToken( ), and validateState( ) functions, operating for example according to the following descriptions and pseudocode.

start( )→Action[ ]
getActions( )→Action[ ]—returns the action set of the current debot state.
getToken( )→(unit128 balance, string name, string symbol)—returns info about the token if the target smart contract supports a token wallet interface, otherwise throws an exception.
validateState(Action[ ] action_set)—a function that may be defined to be called as real blockchain transaction. This function takes an action set that, when executed, may achieve the necessary DeBot state. Then that state may further be compared to a local DeBot 301 state.
In addition, the DeBot interface may include additional functions associated with particular actions.

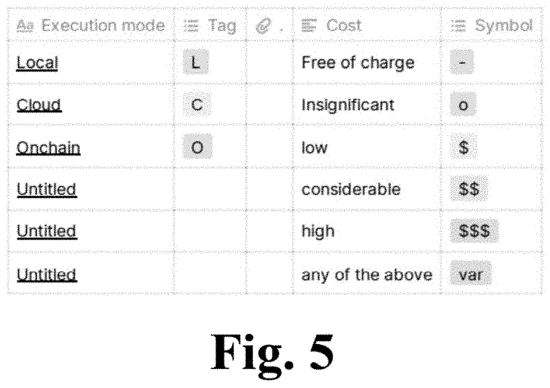

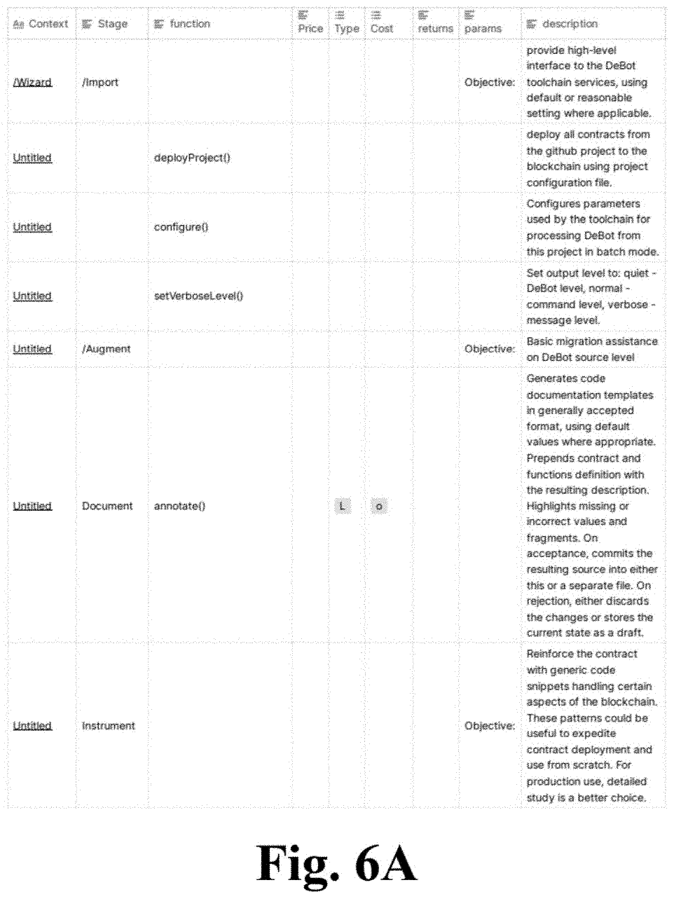

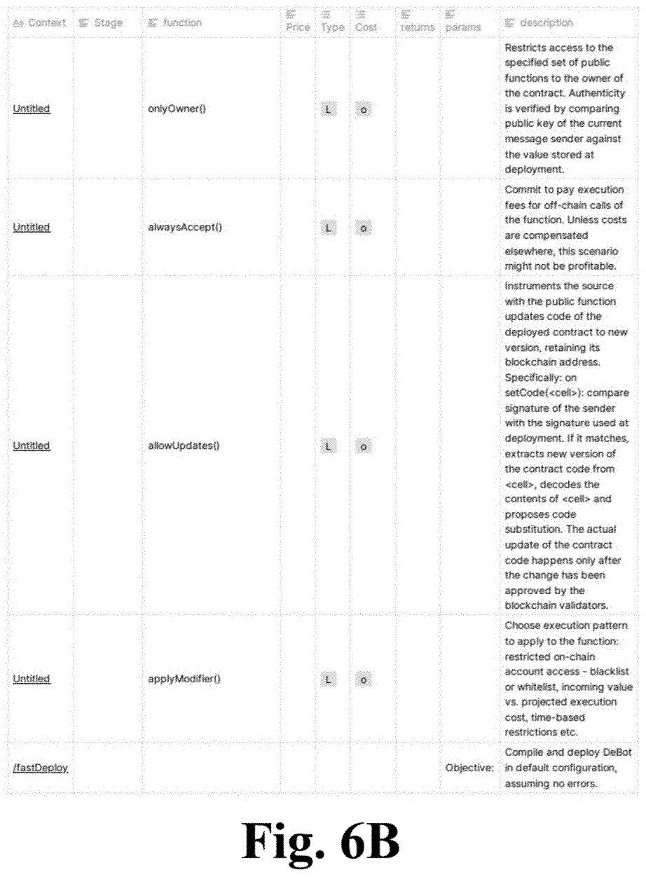

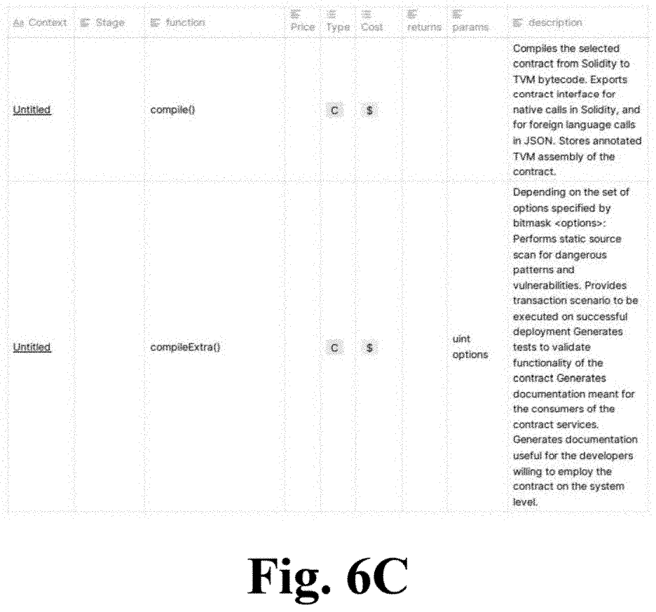

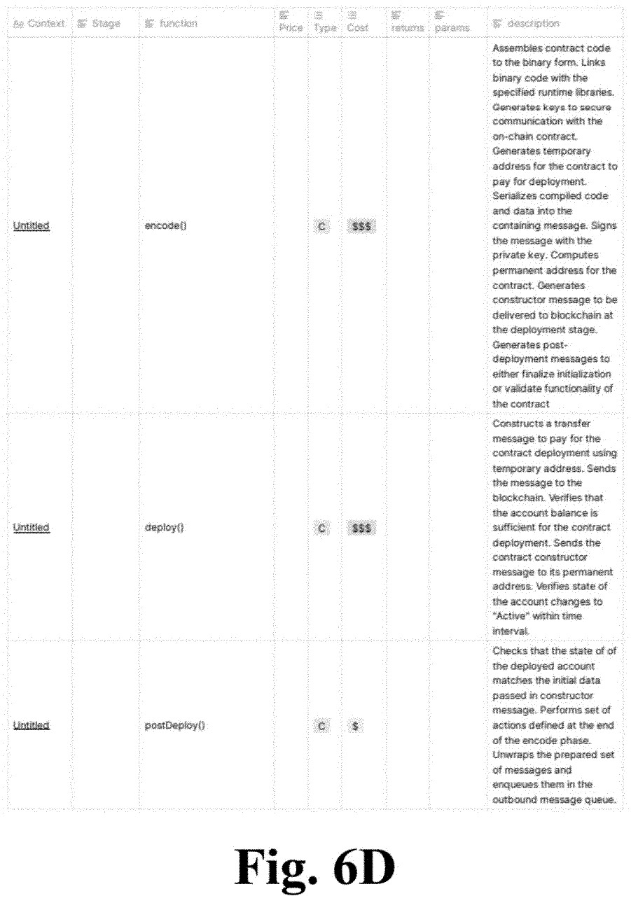

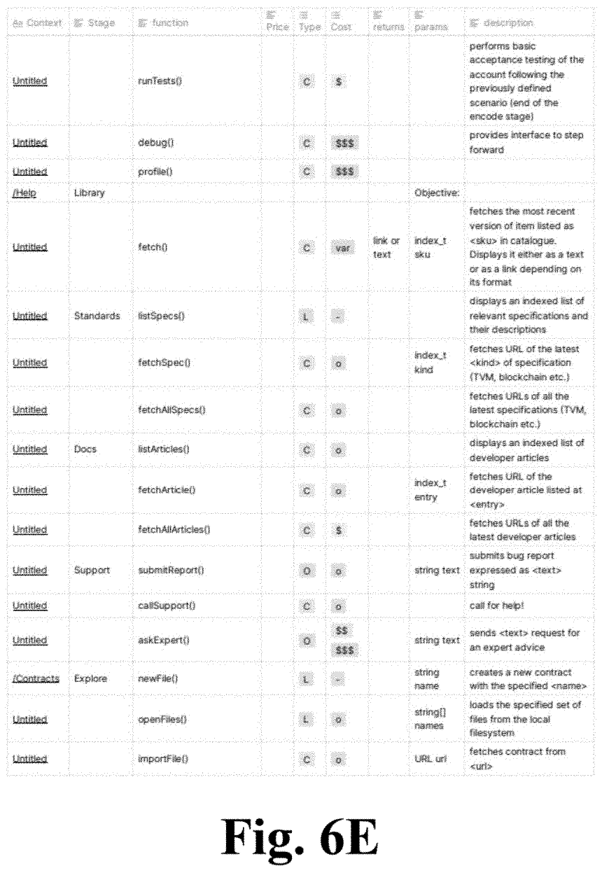

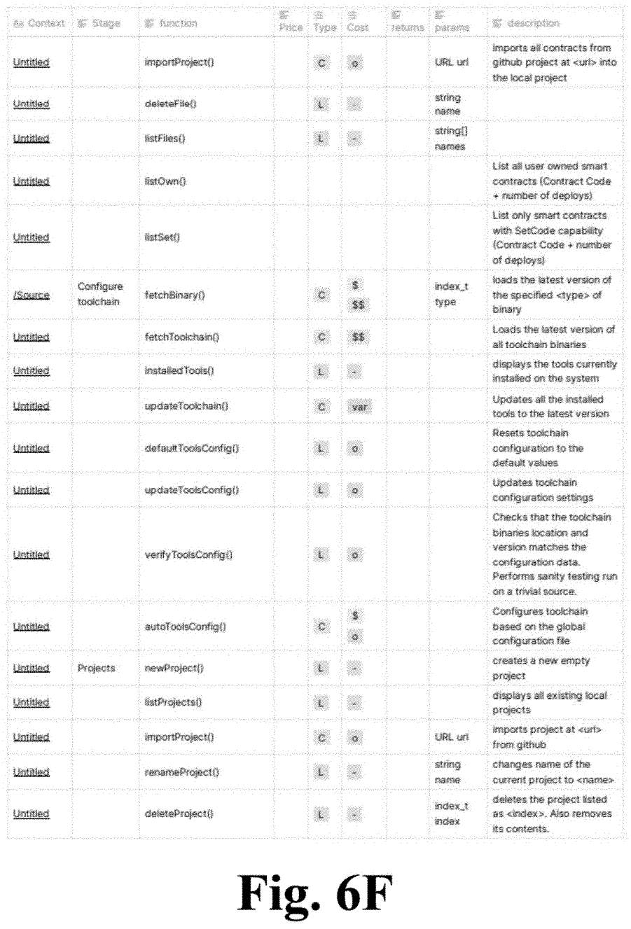

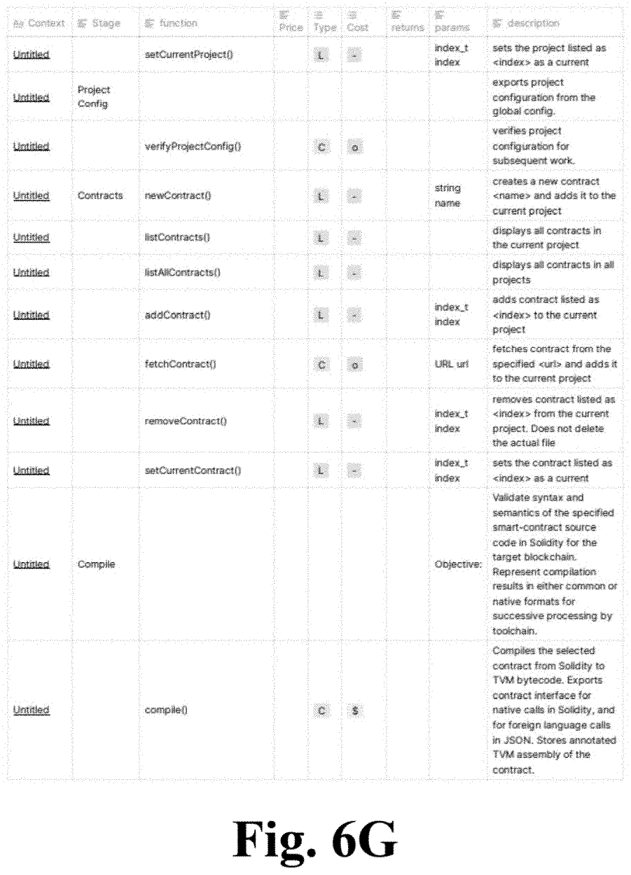

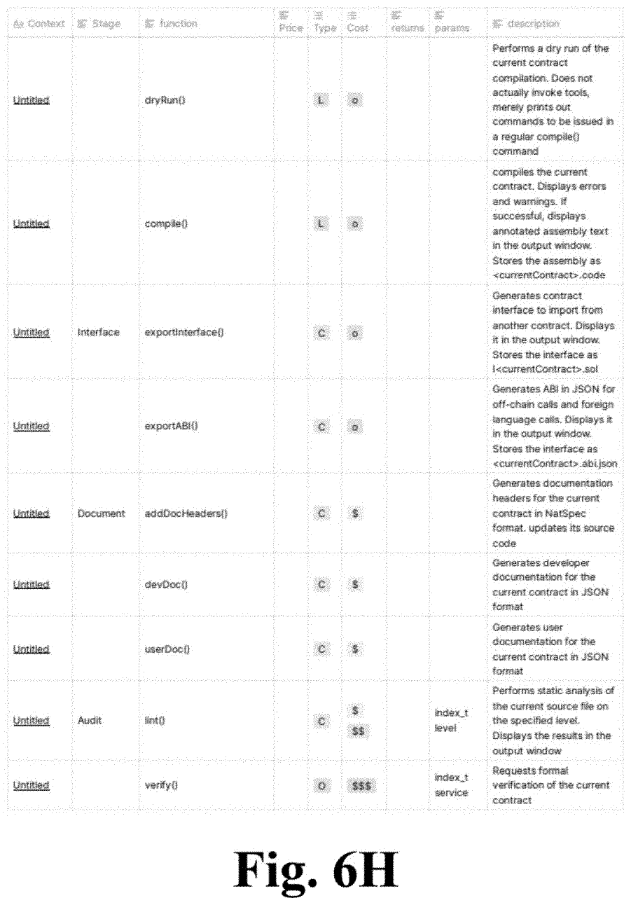

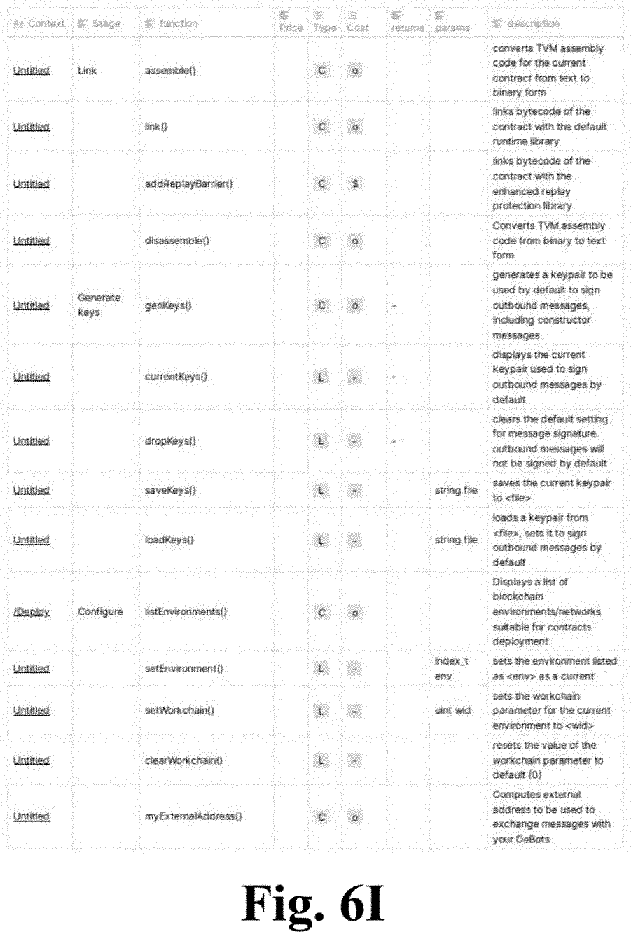

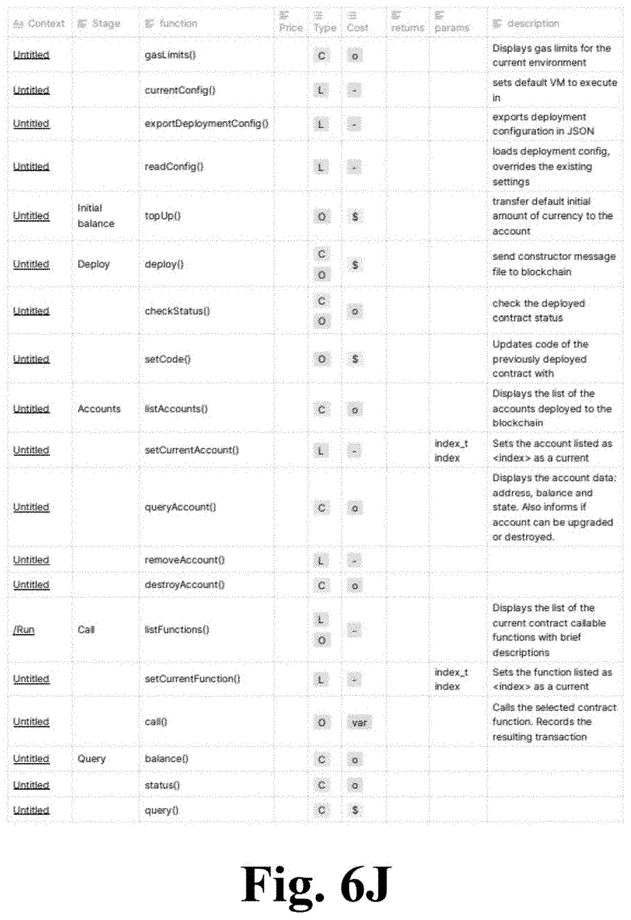

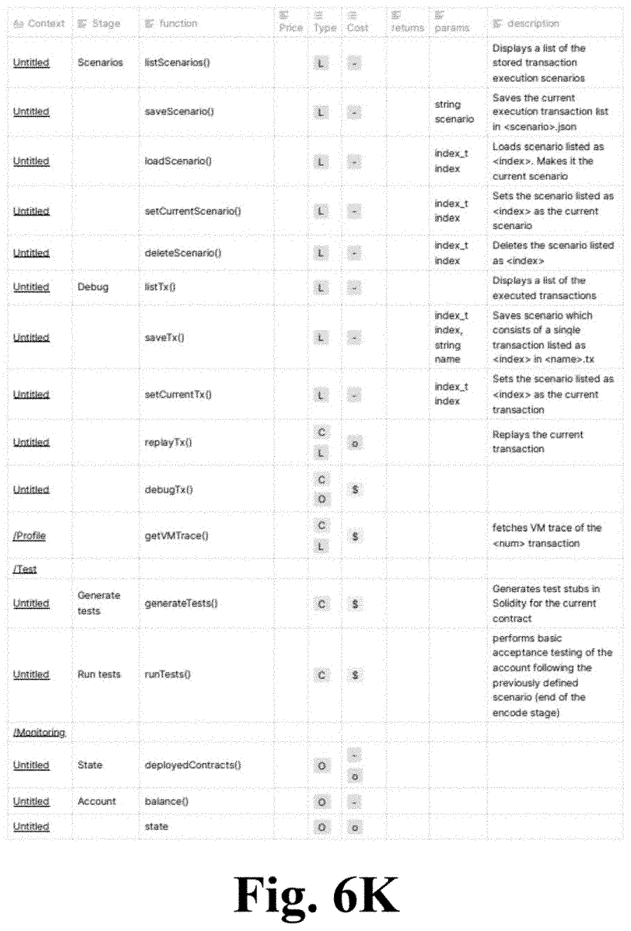

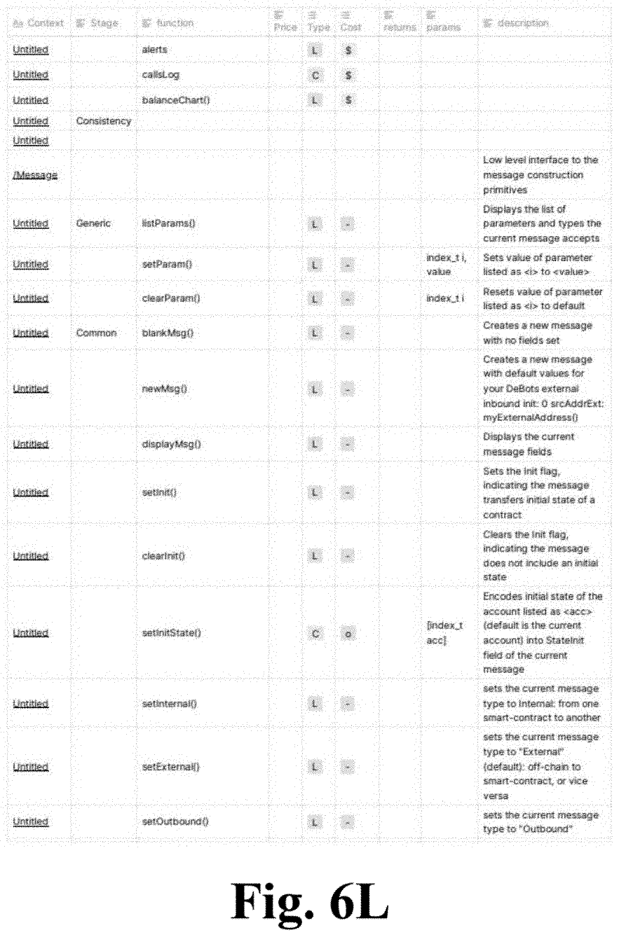

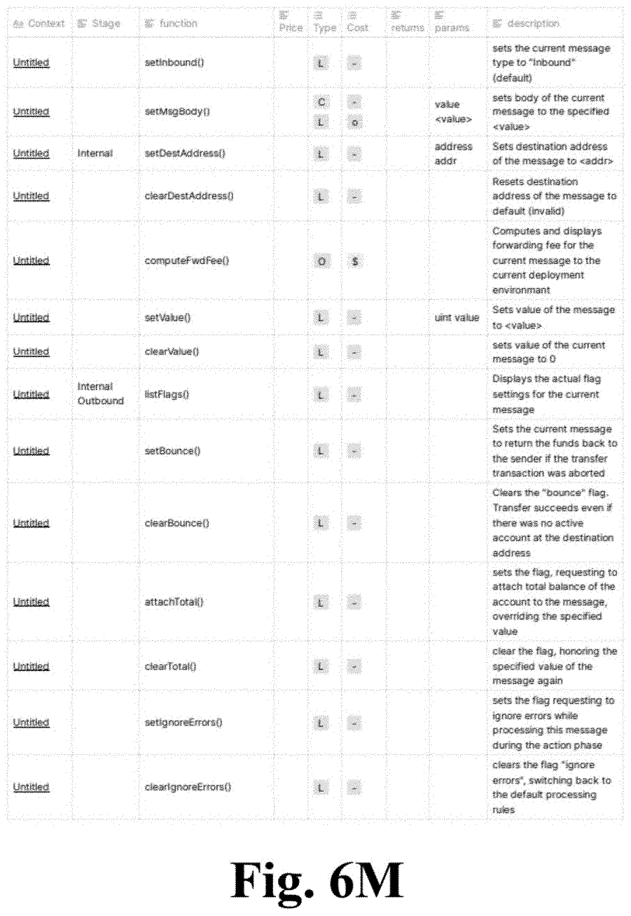

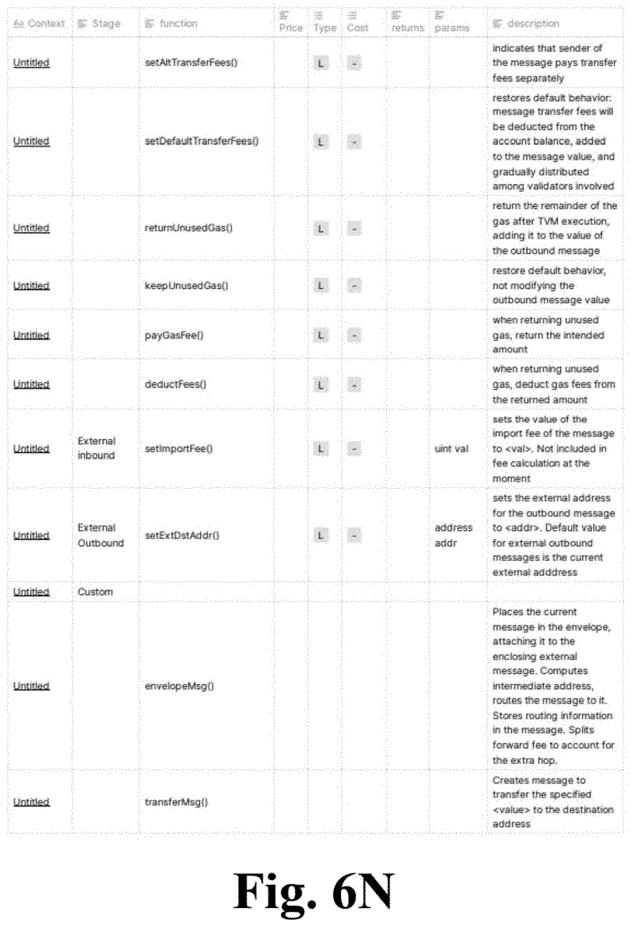

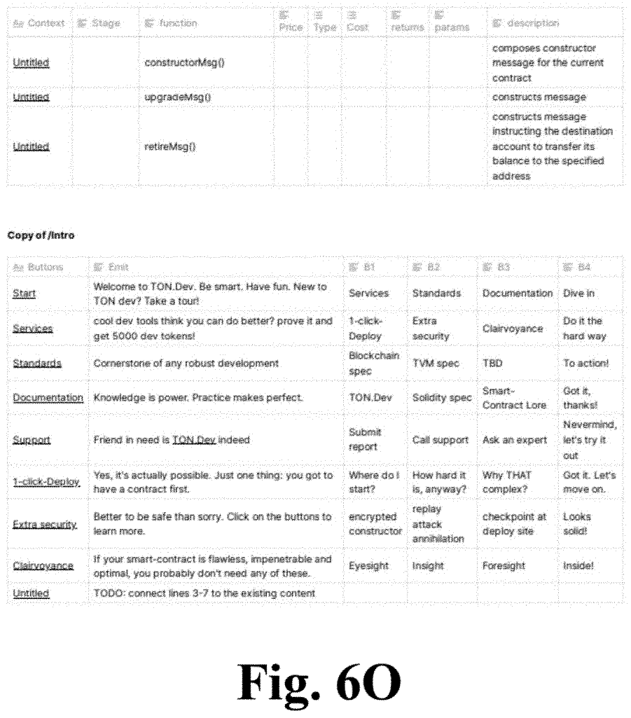

FIG. 5 is a legend for the fuller understanding of exemplary command function descriptions usable in accordance with embodiments of the present invention, as set out in FIGS. 6A-6O.

FIGS. 6A-6O set out exemplary command function descriptions usable in connection with the blockchain-integrated and decentralized systems, methods and apparatuses of the present invention.

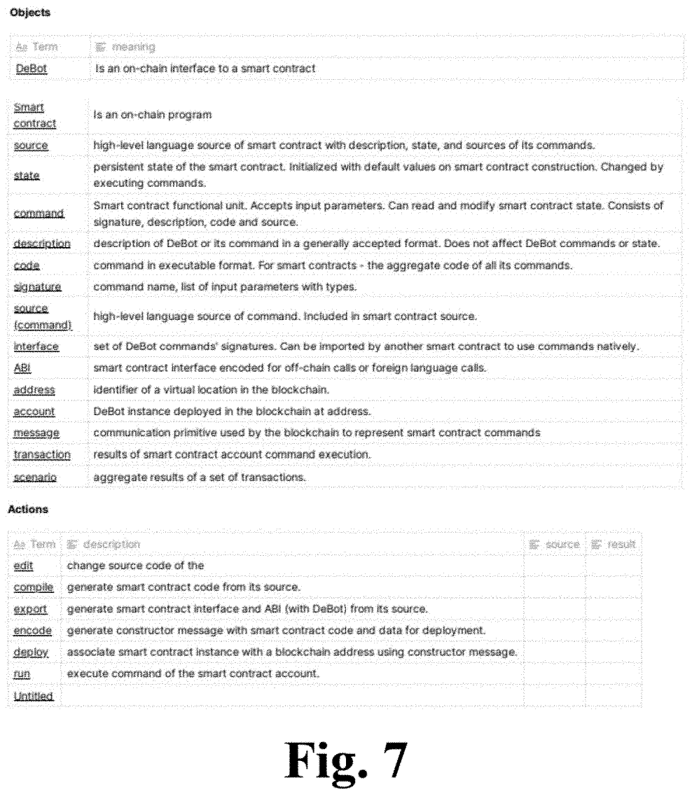

FIG. 7 is an object and action list for the fuller understanding of the exemplary function descriptions usable in accordance with embodiments of the present invention, as set out in FIGS. 6A-6O.

It will be understood that such command functions and the associated explanatory materials are merely exemplary, and that additional or modified command functions may be used in accordance with embodiments of the invention.

According to a further embodiment of the present invention, one or both of user actions and the contract state may be verified. This verification will be set out with to an exemplary system involving a multisignature smart contract DeBot interface where the method for verification is based on user interaction with this multisignature smart contract.

According to such embodiment, the DeBot browser may save an interaction sequence of local DeBot actions, and has the ability to, at any time, verify this sequence by calling a validateState function of a DeBot on the blockchain 400. The validity of the user actions can accordingly be verified based on receipt of a response from the remote DeBot with the result of the actions sequence. It can accordingly be assumed that the user actions which led to the correct DeBot execution have been verified, provided that an appropriate data verification process is performed.

Such appropriate data verification may, according an aspect of the invention, be performed by execution of a proof using a Local Virtual Machine—for example, such a TON Virtual Machine as has been published by TON Labs. In a further embodiment, the proof may be a Merkle proof.

Such data verification process may be carried out by adding serialized BOC (Bag of Calls in TON) into all data records obtained pertaining to the client. For example, an account proof process may be loaded into the SDK made up of the following steps:
1. Deserialize BOC
2. Check JSON correctness with respect to struct from BOC
3. Load shard state root hash
4. Check proof for account in shard state
5. Load block
6. Check proof for shard state in block
7. Load shard
8. Load master chain block
9. Check shard proof (for example by comparing hashes in proof and state's update—e.g. Merkle update—in block)

In another aspect of the invention, there may be a multisig (that is, “multi-signature”) wallet DeBot. Such multisig wallet DeBot may be executed according to the initiation of a start function, which start function may generate an output action. Pseudocode that may be representative of such function may be as follows:

Action {
description: “”,
name: “setPendingTransactions”,
type: run_method,
context: “getTransactions”,
}

Through such functionality, a list of pending transactions in the multisig contract may be obtained an initial list of actions for the user associated with client 100 may be prepared.

As a further part of the functionality of the multisig wallet DeBot, the DeBot browser may call a getTransactions function of the multisig wallet and may further call the DeBot's setPendingTransactions function, inputting into this setPendingTransactions function the list of pending transactions in the multisig contract. This setPendingTransactions function may generate a list of actions, for example according to the following exemplary pseudocode:

Action {

description: “Transaction” + transId + “ dest:” + dest + “amount:” +
amount,
name: “”,
type: run_action,
context: “{input: [

{name: confirm, type: button, run: confirmTransaction},
{name: details, type: button, run: getTransactionDetails}

]”,

}

As yet a further part of the functionality of the multisig wallet DeBot, the DeBot browser may call a getActions function of the DeBot. The DeBot may, in response, return or output actions, for example in a manner that may be rendered, for example to the user associated with client 100, in the general manner of the following:

Hello, dear custodian! You have several pending transactions:
1. Transaction 0x14224214, dest: 0x4234234234235435634654645645646, amount: 10GR
/confirm—to confirm
/details—to see more details about transaction.
2. . . .
/submit—to create new transaction.
/manage_limits—to view/create/delete/confirm limits.
/update—to submit or confirm multisig wallet code update.

In response to receiving such action-related information, the user may choose, for example, one or more or all of confirming a certain transaction, submitting a new transaction, and/or moving to a manage_limits screen where new actions may be displayed to operate with multisig limits.

In yet a further embodiment of the present invention, a DeBot notification service may be provided. This may take the form of a decentralized notification service, and its functionality may involve both the emission or transmission of messages and the storing of message-associated addresses or identifiers (for example in the form of a message-associated hash).

Message-specific information, such as a message body, may be stored, for example along with user-specific information, such as a user action and/or a user identification (e.g. a user mobile ID). This storage may be made within persistent, decentralized storage, for example the persistent storage of a smart contract (which may be a blockchain-associated smart contract).

One or more oracles listening to or monitoring the messages (and preferably all the messages) emitted by such smart contract, including the messages (and again preferably all the messages) received from DeBots, may push notifications associated with the messages using the user-specific information (such as a user mobile ID), and may accomplish such push notifications through a notification provider, which may be a centralized mobile notification provider (e.g. those made available by Google or Apple).

In a further aspect of the DeBot notification service, such oracles may store additional user-specific information, such as a User device token, in order to be able to securely send user notifications, while enabling the smart contracted generated messages to be verified by the user on the user's device. The user which receives such notification, for example on their mobile phone, may be permitted to safely compare the message's address or identifier (such as a message-associated hash) with corresponding blockchain information (such as the same message-associated hash), in order to verify that the messages indeed contains valid information sent by the smart contract. In this manner, the DeBot notification service may provide for safe verification by the user of the messages sent by DeBot, advantageous protecting against such malicious activity as phishing attempts. Advantageously, such verification can safely occur even absent reliability of the message-emitting oracle or the oracles in general which, from the user's perspective, may possibly have sent the message.

Advantageously, security problems inherent in authentication over SMS and other push notifications may be obviated, without the need to resort to such cumbersome and potentially insecure approaches as two factor authentication.

In yet a further embodiment of the current invention, decentralization may be achieved with respect to a software terminal (including preferably the entirety thereof). This software terminal may be in the form of a user interface, and may be used, for example, for scripting, customization commands, options configurations, program development, and/or the like. The user interface may, for example, be in the form of a command line type interface. It may be in the form of a bot, that is, an interface for an automated chat (or a chat with a machine) The interface may contain two main areas: a text input area and an output area where inputs from all chat participants as well as system messages are displayed. Options, including for example text and picture formatting options, may also be presented as part of the interface. Through such interfaces, depending on the context of use, commands may be entered in the input area (for example when the chat is with a bot/machine). The commands may be made in the form of a human-like dialog, but, as this may be annoying or difficult, commands may be in the form of the selection of commands from a menu of options (e.g. by selecting an appropriate button corresponding to a command). These commands may be integrated with other systems, by way of example, with the commands used to deploy particular Amazon Web Services functions. The interface may be in the form of a text terminal or text editor or shell, and may allow for the editing of scripts or programs within the execution environment. It will be understood that any of a variety of user interfaces of types known in the art may be employed in connection with the decentralized software terminal of the current invention.

According to aspects of the current invention, user interactions with the terminal may be made with a DeBot 301 in the manner described herein, so that the software terminal interaction itself, as well as the code execution, becomes, through function calls to DeBots and an associated blockchain, blockchain-associated. Therefore, such user interaction need not rely on so-called “trusted” infrastructure or services. Through such advance, secure and blockchain-based mobile interaction may be achieved. For example, this may take the form of code editor and/or compiler accessible through a mobile device but ultimately relying on blockchain-associated security and processing power.

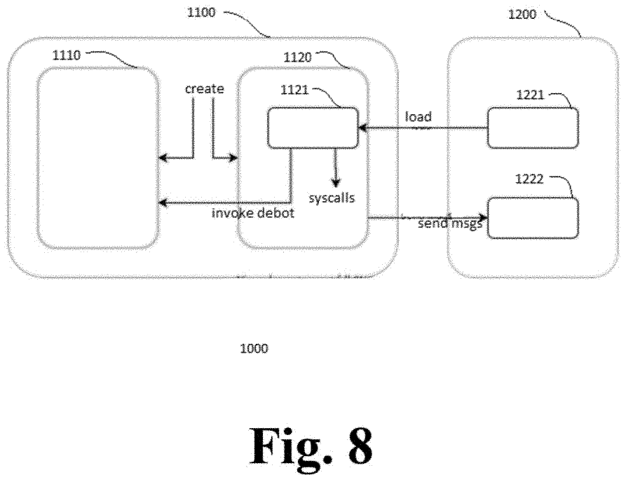

FIG. 8 is an exemplary system architecture and functionality diagram showing, in the form of a DeBot platform 1000, interaction between a DeBot Browser 1100, a number of DeBots (e.g. 1121; 1221), and a blockchain 1200, according to embodiments of the present invention. It will be seen, for example with reference to this DeBot platform system, that in certain embodiments of the current invention, implemented may occur using Interfaces instead of or in addition to Actions.

The DeBot platform 1000 may include a DeBot smart contract 1221 (which may be located on, or deployed to, a blockchain 1200), a DeBot Browser 1100, (which may have one or more DEngines (1110;1120) each of which may have the structure as shown in DEngine 1120) and one or more target smart contracts 1222 (which may also be located on, or deployed to, the blockchain 1200). In certain embodiments, the target smart contract 1222 can have or be associated with several DeBots, and in certain embodiments several target contracts 1222 can have or be associated with a single DeBot.

The DeBot browser 1100 may be run on a client 100. The DeBot browser may download DeBot code and may run this DeBot code within a DEngine.

DeBot, as discussed herein, may be arranged as a smart contract, which smart contract may be isolated from other smart contracts and DeBots and from the blockchain. The specific capabilities and functionalities of a DeBot may be limited by or limited to the commands of a virtual machine on which the DeBot is executed.

In further embodiments, DeBot may have the following the capabilities or functionalities of one or more or all of (1) receiving input from users, (2) querying info about other smart contracts or other DeBots; (3) querying transactions and messages; (4) receiving data from external subsystems (for example, a file system) and/or external devices (for example, an NFC, a camera or the like); and (5) calling external function libraries, such as those that allow operations which may not be supported by the virtual machine—by way of example, working with json, converting numbers to string and/or strings to numbers, encrypting, decrypting, signing data, and the like.

In aspect of the invention, such additional capabilities or functionalities may be supported by one or more interfaces such as DeBot Interfaces (DInterfaces) which can be used as to DeBots and which may be supported in DeBots Browsers. These interfaces may preferably have one or more or all of the features of (1) being comprehensive, for example in that the interface describes many or all types of communication accessible on modern devices, (2) being universal, for example in that the interface may not require specific operating systems and/or hardware in order to operate; (3) being atomic, for example in that every communication channel may be flexibly described in the interface, advantageously providing flexible resource access management, and (4) being convenient, thereby allowing even low-skilled developers the interface as to DeBots that they may be using.

In certain embodiments of the invention, The DeBot Engine may act like or as a proxy between a DeBot Browser and a DeBot. The DeBot Engine may further have built-in implementation of DInterfaces, for example a simple version thereof, which may for example permit working with json.

In a further embodiment, the manifest for DeBots is described. For example, a DeBot developer may describe all needed interfaces in this manifest and the DeBot Browser may check the manifest, for example with respect to the presence of the needed interface, prior to running or executing a DeBot. Advantageously, this manifest may maintain the security and privacy of users when using DeBots.

In another aspect, a DeBot, or indeed every DeBot, may declare which DInterfaces it will use. For this purpose it may have a get Required Interfaces( ) function which may return an array or other set of required interfaces.

Every interface may have an id, for example an unsigned 256-bit integer and an address which is used in DeBots as a destination address of internal messages. The address may be a standardized address (for example, a standard TON address) and may consisting for example of DEBOT_WC (equal to 0xDB) as a workchain_id part and interface id as an address part. Reference may be made to the “Telegram Open Network Blockchain” specification, section 3.1.2 for additional possible implementation details, particularity with respect to a TL-B scheme for address.

As one example of an implementation according the present invention, a getRequiredlnterfaces( ) function may be implemented in the manner of the following pseudocode:

// Base contract for all debots
abstract contract Debot {

i32 constant DEBOT_WC = −31;
function getRequiredInterfaces( ) virtual returns (uint256[ ]
interfaces);

}
contract DebotA is Debot {

function getRequiredInterfaces( ) override returns (uint256[ ]
interfaces) {

return [ID_TERMINAL, ID_MENU, ...];

}

}

In further embodiments of the present invention, a DInterface may be used in DeBot. To use an interface a DeBot may import a source file with a DInterface declaration and may call its methods in the manner of a smart contract method, (for example how methods are called in TON) for example by sending internal messages to an interface address.

Before running the DeBot, a DeBot Browser may provide callbacks for DEngine, for example to receive all requests to DInterfaces. Requests may be packed into internal messages. When the browser receives a message from DEngine it may unpack the message, decode its body, call a DInterface function, pack the results into an internal message and return it to DEngine using Dengine.send(msg).

As one example of an implementation according the present invention, a BrowserCallbacks( ) function may be implemented in the manner of the following pseudocode:

interface BrowserCallbacks {

// Message from Debot to Browser with encoded DInterface call

send(message: string) −> Promise<void>
// Request from Dengine to approve some action (for example,

send mesage to blockchain)

approve(action: { }) −> bool
// Request from Debot to call another debot
invoke(debotAddress: string, message: string) −> Promise<void>

}

Before starting a DeBot, metadata may be provided, which metadata may include the DeBot's name, version, authorship information, description, language and/or ABI. This may be accomplished using a getDebotInfo( ) mandatory function. Along with getRequiredlnterfaces( ), this function may be defined in a base contract (e.g. Debot.sol).

A base contract for each DeBot may be defined the manner of the following pseudocode:

abstract contract Debot {

i32 constant DEBOT_WC = −31;

function getDebotInfo( ) public functionID(0xDEB) view virtual returns(

string name, string version, string publisher, string key, string author,
address support, string hello, string language, string dabi, bytes icon);

}
contract DebotA is Debot {

function getDebotInfo( ) public functionID(0xDEB) override view returns(

string name, string version, string publisher, string key, string author,
address support, string hello, string language, string dabi, bytes icon

) {

name = “DebotA”;
version = “0.1.0”;
publisher = “TON Labs”;
key = “description”;
author = “TON Labs”;
support = address.makeAddrStd(0,

0x841288ed3b55d9cdafa806807f02a0ae0c169aa5edfe88a789a6482429756a94);

hello = “Greetings”;
language = “en”;
dabi = m_debotAbi.get( );
icon = m_icon;

}

}

Before starting the DeBot, the DeBot Browser may create a new instance of DEngine with the address of the DeBot. The DEngine may then download a DeBot state, query metadata and list of DInterfaces required by DeBot, and return the list to the browser. The browser may then check that it supports all required DInterfaces. If one of interfaces is not supported, Browser may report an error to the user and/or application and not start the DeBot. If the interfaces are supported, the browser may provide or display a list of requested interfaces to the user and/or application. The required interfaces may then be approved by the user or application. Then, after the list of interfaces is approved, the DeBot Browser may start the DeBot, for example using Dengine.start(callback).

On every interface call, the browser may check the permissions for DeBot and on success execute the DeBot, for example according to any applicable isolation requirements that may be needed.

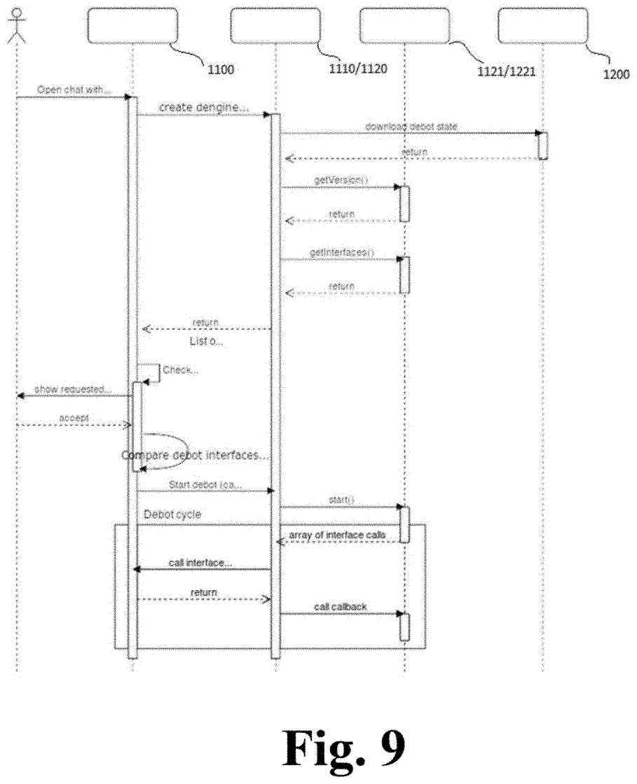

FIG. 9 is an exemplary function and information flow diagram showing interaction between a DeBot Browser 1100, a DEngine 1110/1120, a DeBot 1121/1221, and a blockchain 1200 according to embodiments of the present invention. In particular, an exemplary start sequence is shown with respect to the interaction of these system components.

In further embodiments of the present invention, a DeBot Browser may support and/or implement DInterfaces. For example, any or all DInterfaces published in a DIS repo may be supported and/or implemented, and the particular interfaces support and/or implementation may be selected based on a browser's capabilities. For example, it may be determined that a console browser cannot support external devices like camera, NFC, microphone and so on, and thus that corresponding DInterfaces will not be supported and/or implemented.

Interfaces used for basic DeBot operation may be built into the DEngine itself, for example in the form of an SDK, Hex, or JsonDeserialize. They may be marked as such, for example in respective readme files in an IS consortium repository.

In further embodiments of the present invention, versioning the DEngine may be achieved. In another aspect, DEngine in the form of an SDK module may have a version of SDK itself. DIS statuses may include, for example, Proposed, Accepted, and Published.

One exemplary example of a DInterface, according to an embodiment of the invention, is as set out below

-----
Name: RawInput
ID: 8796536366ee21852db56dccb60bc564598b618c865fc50c8b1ab740bba128e3
Description: Allows obtaining of a string from a user
Functions:

Function input

arguments:

answerId: uint32 - function id of result callback
prompt: bytes - string printed to the user and describing what to enter

returns:

text: bytes - string entered by user

A Declaration in Solidity may conform to the following pseudocode:
interface IRawInput {

function input(uint32 answerId, string prompt) external returns (string value);

}
Library Rawinput {

uint256 constant ID_RAWINPUT =

0x8796536366ee21852db56dccb60bc564598b618c865fc50c8b1ab740bba128e3

// Callback Function Prototype
function inputResult(uint32 answerId, string prompt) public {

address addr = address.makeAddrStd(DEBOT_WC, ID_RAWINPUT);
IRawInput(addr).input(answerId, prompt);

}

}
A declaration in C++ may conform to the following code:
namespace tvm { namespace schema {
_{——}interface IRawInput {

[[internal, answer_id]]
string input(string prompt);

};
A code Example, with respect to solidity, may be as follows:
Solidity
pragma solidity >=0.6.0;
import “Debot.sol”;
import “RawInput.sol”;
contract ExampleDebot is Debot, RawInput {

function start( ) public {

Rawlnput.input(tvm.functionId(inputResult), “enter your name:”);
Rawinput.input(tvm.functionId(inputResult), “enter your wallet address:”);

}
function inputResult(string text) public override {

require(text == “Debot”);

}

}

Additional features and functionality, particularly with respect to C++ implementation of DeBots, may be added according to available programming techniques and available or developable functions.

In further aspects of the invention, DeBots have additional features and functionality, including (1) calling get-methods of target smart contracts, (2) calling external functions of target smart contracts on-chain, and (3) invoking other DeBots in a local environment.

Features (1) and (2) may be facilitated by DeBots producing external inbound messages. For example, this production may itself be facilitated by the the execution of the DeBots in DEngine, thus allowing generation of this sort of message, and, in further embodiments, also to send them to the blockchain and have results of the blockchain-based execution returned to the DeBots.

In further embodiments, these DeBot-related features may be implemented in a mative manner, include without reliance on the DInterfaces. For example, communication may be made between two smart contracts, e.g. by sending one smart contract or DeBot sending messages directly to a target address associated with a second smart contract or DeBot.

However, in certain embodiments, to call a get-method or call a function on-chain, a DeBot may generate an external inbound message, while to invoke another DeBot, it may generate an internal message to the invoked DeBot address.

The DEngine may distinguish between get-methods and on-chain calls, for example by examining the sign header of the message. Signed messages, e.g. with the sign being set to true, may be considered on-chain calls, while unsigned messages, e.g. with the sign being set to false, may be considered to beget-method calls.

In a further embodiment of the invention, a developer example of pseudocode with respect to solidity may be as follows;

// Solidity

function showTasks(uint32 index) public view {

index = index;
optional(uint256) none;
ITodo(m_address).getTasks{

abiVer: 2,
extMsg: true,
sign: false,
pubkey: none,
time: uint64(now),
expire: 0,
callbackId: tvm.functionId(showTasks_),
onErrorId: tvm.functionId(onError)

}( );

}

In further embodiments of the invention, further support within DEngine may be implemented. DEngine may execute a DeBot and check if it produces external inbound messages. If so, then DEngine may analyze each message, for example by scanning signature and public key bits in message body to understand if the message is intended for a get-method call. If bits are zero, DEngine may download a target contract and run its get-method, then return results to DeBot, for example by calling its function set in the callbackId or onErrorId (in case of errors) headers of a message body.

### Onchain Function Call

In a further embodiment of the invention, a developer example of pseudocode with respect to an on chain functional call may be as follows:

// Solidity

IMsig(m_msigAddress).sendTransaction{

abiVer: 2,
extMsg: true,
: true,
pubkey: pubkey,
time: uint64(now),
expire: 0,
callbackId: tvm.functionId(waitBeforeDeploy),
onErrorId: tvm.functionId(onErrorRepeatCredit)

}(m_address, INITIAL_BALANCE, false, 3, empty);

}

According to a further embodiment, DEngine may execute a DeBot and check if it produces external inbound messages. If there is one, DEngine may analyze if it is an on-chain call, for example by scanning signature and public key bits in message body. DEngine may then perform the following actions, for example selectably in the event that the signature bit is 1: (1) cownload target smart contract, sign the message and emulate its transaction locally; (2) check if transaction produces outbound internal messages, for example such messages with funds; (3) requests permission from a DeBot Browser to send this message on-chain—the request may contain information about funds that will be spent if message will be executed on-chain, and may further contain the message itself; (4) for example selectably based on whether the DeBot Browser allows message sending, the DEngine may send the message to a blockchain.

In a further aspect of the invention, a DeBot can call another DeBot, for example by simply sending an internal message to it.

After DeBot execution, DEngine may filter all internal messages produced by DeBot, for example those with destination addresses with workchain 0. Such a filter allows separation of DInterface calls (which may have 0xDB workchain id) from DeBot invokes. If there are invoke messages, DEngine may send them to a browser, for example through a BrowserCallbacks interface. The browser (or a user or client) may be required to approve the invoke of a new DeBot, at which point the browser may create a new DEngine instance, download a target DeBot, and/or transfers the message to the target DeBot. The browsers may be configured to support functionality to support messages from several DeBots, by way of example, a common queue.

In a further embodiment of the present invention, security with respect to the system may be improved. For example, at the start of the processes discussed herein, the browser may create a DEngine instance, and may receive DeBot metadata and a list of required DInterfaces, (e.g. through DEngine) and may check them for compatibility and security.

Further, when a DeBot is running, DEngine may proxy all DInterface calls (or calls aside from calls to built in interfaces supported by the engine itself, such as SDK calls). This proxying may be done directly to the browser, and the browser may be required to decide whether to execute or reject the calls.

The system may, in further embodiments, be configured such get-method calls are universally allowed, and such calls may be executed by DEngine. External function calls may require approved by the browser, and such calls, to the extent approved, may also be executed by DEngine. The system may further be configured such that other DeBots calls are always allowed. However, they may be executed by the browser, and the browser may be configured with the capability to block invokes on an as-needed basis.

In an aspect of the invention, there is a decentralized blockchain-associated system including a specialized node adapted to be integrated with a blockchain, and further adapted to be in operative communication, over an internet, with a client, the specialized node comprising a decentralized bot, a smart contract, and business logic, where the decentralized bot is integrated with the smart contract and is adapted to perform a sequence of actions of a user associated with the client through calls to functions of the smart contract. In a further aspect, the specialized node is adapted for communication with the client through a browser or stand-alone application and an interface at the client's end. The interface at the client's end may be a graphical user interface, and actions of the decentralized bot may be represented to the user as graphical elements.

In yet a further aspect, the smart contract contains both the decentralized bot and the business logic. In one more aspect, the decentralized bot is adapted to provide a user interface to the user for use in communication with a smart contract program on a blockchain via a specialized node, and the user interface may further be adapted to emulate a software terminal and permit the user to engage in scripting, customization, options configuration, or software development, through function calls to the decentralized bot that become blockchain-associated and verifiable through the blockchain. The system may further include a local virtual machine associated with the blockchain, with the local virtual machine being adapted to facilitate execution of the sequence of actions of the user by the decentralized bot.

In a further aspect, the specialized node may be adapted to transmit a result of the sequence of actions of the user together with the sequence itself to a remote blockchain-associated smart contract, and thereby to permit the user to verify the sequence and the result. The specialized node may be adapted to transmit an address of the smart contract or the decentralized bot to the user. In an embodiment, the decentralized bot is adapted to serve as the user's interface for a flow of communication between the user and a target blockchain-associated smart contract.

The system may further include a decentralized bot browser program adapted to execute the decentralized bot's performance of function calls and parse the output of the decentralized bot resulting from the performance.

In an aspect, the specialized node may be adapted to transmit a copy of the decentralized bot to the client for execution on a decentralized bot browser instance of the client.

In yet a further aspect, at least one of the sequence of actions may include a description, a name, a type, an id, a current step and a context.

In one more aspect, the specialized node may further include a server adapted to perform the operative communication with the client, and further include a storage database associated with the server. The server may be a GraphQL Server and the operative communication may be adapted to be performed by GraphQL protocol.

In a further embodiment, the decentralized bot integrated with the smart contract may be adapted to be stored on the block-chain and executed on a local computer of the client.

In a further embodiment, the decentralized bot may be adapted to invoke a target decentralized bot so as to permit performance of a combined flow of several actions with at least one of the several actions being performed by the decentralized bot and at least one other of the several actions being performed by the target decentralized bot. In another aspect, the sequence of actions of the user may be pre-programmed.

In yet a further embodiment, the decentralized bot may be adapted to prepare messages according to actions of the user and send the messages to a target smart contract on the blockchain for execution.

In a further embodiment of the present invention, there exists a method for decentralized verification with respect to a smart contract, include the steps of: saving, using a decentralized bot browser, a user interaction sequence that pertains to the smart contract and that involves a local decentralized bot; and verifying, using the decentralized bot browser, the user interaction sequence by calling a state verification function of a remote decentralized bot on a blockchain to verify the state of the remote decentralized bot, and by receiving, at the decentralized bot browser, a response from the remote decentralized bot as a result of the state verification function call that includes a result of the sequence of actions. The smart contract may be a multisignature smart contract. The step of verifying may include execution of a proof on the response using a local virtual machine, and the proof may be a Merkle proof.

In one additional embodiment of the present invention, there is a method of providing a decentralized bot-based notification service, including the steps of: storing, using a decentralized bot, in persistent storage of a blockchain-associated smart contract, message-specific information comprising a message body and a message identifier, and user-specific information comprising a user identification for an intended recipient of the message; issuing, through a notification provider, a push notification associated with the message to the intended recipient using the user identification, wherein the push notification permits the user to retrieve the message body and the message identifier; and permitting the user to verify, based on a comparison of the message identifier and using the decentralized bot, that the message was sent by the smart contract.

It will accordingly be seen that the objects set forth above, among those made apparent from the preceding description, are effectively and securely attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also understood that the following claims are intended to cover all of the generic and specific features of the invention herein described and all statements of the scope of the invention which, as a matter of language, might be said to fall therebetween. Certain embodiments of the present disclosure may include none, some, or all of the above technical advantages. One or more other technical advantages may be readily apparent to one skilled in the art in view of the figures, descriptions, and claims of the present disclosure. For example, technical advantages of one or more embodiments may additionally include (1) achieving additional decentralization, including in certain cases an approximation or achievement of end-to-end decentralization, (2) achieving additional integration of the user interface with various forms of blockchain functionality, and (3) decreasing reliance, particularly with respect to the user interface, on so-called “trusted” architecture or services.

What is claimed is:

1. A decentralized blockchain-associated system comprising:
a specialized node adapted to be integrated with a blockchain, and further adapted to be in operative communication, over an internet, with a client, the specialized node comprising a decentralized bot, a smart contract, and business logic, wherein the decentralized bot is integrated with the smart contract and is adapted to perform a sequence of actions of a user associated with the client through calls to functions of the smart contract.

2. The decentralized blockchain-associated system of claim 1, wherein the specialized node is adapted for communication with the client through a browser or stand-alone application and an interface at the client's end.

3. The decentralized blockchain-associated system of claim 1, wherein the smart contract contains both the decentralized bot and the business logic.

4. The decentralized blockchain-associated system of claim 1, wherein the decentralized bot is adapted to provide a user interface to the user for use in communication with a smart contract program on a blockchain via a specialized node.

5. The decentralized blockchain-associated system of claim 4, wherein the user interface is adapted to emulate a software terminal and permit the user to engage in scripting, customization, options configuration, or software development, through function calls to the decentralized bot that become blockchain-associated and verifiable through the blockchain.

6. The decentralized blockchain-associated system of claim 1, wherein the system further comprises a local virtual machine associated with the blockchain, and wherein the local virtual machine is adapted to facilitate execution of the sequence of actions of the user by the decentralized bot.

7. The decentralized blockchain-associated system of claim 1, wherein the specialized node is adapted to transmit a result of the sequence of actions of the user together with the sequence itself to a remote blockchain-associated smart contract, and thereby to permit the user to verify the sequence and the result.

8. The decentralized blockchain-associated system of claim 1, wherein the specialized node is adapted to transmit an address of the smart contract or the decentralized bot to the user.

9. The decentralized system of claim 1, wherein the decentralized bot is adapted to serve as the user's interface for a flow of communication between the user and a target blockchain-associated smart contract.

10. The decentralized system of claim 1, further comprising a decentralized bot browser program adapted to execute the decentralized bot's performance of function calls and parse the output of the decentralized bot resulting from the performance.

11. The decentralized system of claim 1, wherein the specialized node is adapted to transmit a copy of the decentralized bot to the client for execution on a decentralized bot browser instance of the client.

12. The decentralized system of claim 1, wherein at least one of the sequence of actions comprises a description, a name, a type, an id, a current step and a context.

13. The decentralized system of claim 1, wherein the specialized node further comprises a server adapted to perform the operative communication with the client, and further comprises a storage database associated with the server.

14. The decentralized system of claim 13, wherein the server is a GraphQL Server and the operative communication is adapted to be performed by GraphQL protocol.

15. The decentralized system of claim 1, wherein the decentralized bot integrated with the smart contract is adapted to be stored on the block-chain and executed on a local computer of the client.

16. The decentralized system of claim 2, wherein the interface at the client's end is a graphical user interface, and wherein actions of the decentralized bot are represented to the user as graphical elements.

17. The decentralized system of claim 1, wherein the decentralized bot is adapted to invoke a target decentralized bot so as to permit performance of a combined flow of a plurality of actions with at least one of the plurality of actions being performed by the decentralized bot and at least one other of the plurality of actions being performed by the target decentralized bot.

18. The decentralized system of claim 1, wherein the sequence of actions of the user pre-programmed.

19. The decentralized system of claim 1, wherein the decentralized bot is adapted to prepare messages according to actions of the user and send the messages to a target smart contract on the blockchain for execution.

20. A method for decentralized verification with respect to a smart contract, comprising the steps of:
saving, using a decentralized bot browser, a user interaction sequence that pertains to the smart contract and that involves a local decentralized bot; and
verifying, using the decentralized bot browser, the user interaction sequence by calling a state verification function of a remote decentralized bot on a blockchain to verify the state of the remote decentralized bot, and by receiving, at the decentralized bot browser, a response from the remote decentralized bot as a result of the state verification function call that includes a result of the sequence of actions.

21. The method of claim 20, wherein the smart contract is a multisignature smart contract.

22. The method of claim 20, wherein the step of verifying comprises execution of a proof on the response using a local virtual machine.

23. The method of claim 22, wherein the proof is a Merkle proof.

24. A method of providing a decentralized bot-based notification service, comprising the steps of:
storing, using a decentralized bot, in persistent storage of a blockchain-associated smart contract, message-specific information comprising a message body and a message identifier, and user-specific information comprising a user identification for an intended recipient of the message;
issuing, through a notification provider, a push notification associated with the message to the intended recipient using the user identification, wherein the push notification permits the user to retrieve the message body and the message identifier; and
permitting the user to verify, based on a comparison of the message identifier and using the decentralized bot, that the message was sent by the smart contract.
